(19) United States
(12) Patent Application Publication
(10) Pub. No.: US 2024/0406952 A1
(43) Pub. Date: Dec. 5, 2024

(54) CONTROL APPARATUS, COMMUNICATION SYSTEM, CONTROL METHOD AND PROGRAM

(71) Applicant: NIPPON TELEGRAPH AND TELEPHONE CORPORATION, Tokyo (JP)

(72) Inventors: Hiroko NOMURA, Musashino-shi (JP); Kenji MIYAMOTO, Musashino-shi (JP); Kota ASAKA, Musashino-shi (JP)

(73) Assignee: NIPPON TELEGRAPH AND TELEPHONE CORPORATION, Tokyo (JP)

(21) Appl. No.: 18/700,904

(22) PCT Filed: Oct. 22, 2021
(86) PCT No.: PCT/JP2021/039118

§ 371 Date: Apr. 12, 2024

(51) Int. Cl. H04W 72/1263; H04W 72/566

(52) U.S. Cl. CPC H04W 72/1263; H04W 72/569

(57) ABSTRACT

A control device includes: a scheme determination unit configured to determine whether a packet to which an identifier of a priority is assigned is transmitted in conformity with a grant-free scheme; a time estimation unit configured to estimate a time in which a traffic volume of the packet is equal to or more than a threshold; and a transfer control unit configured to generate a control signal of a signal transfer device so that the signal transfer device transfers a packet that has arrived at the signal transfer device in the estimated time in accordance with the identifier of the priority. The scheme determination unit determines whether the repeated transmission of the packet is performed. The time estimation unit estimates a time in which the plurality of packets arrive at the signal transfer device a predetermined number of times at predetermined time intervals when it is determined that the repeated transmission of the packets is performed.

### TECHNICAL FIELD

The present invention relates to a control apparatus, a communication system, a control method and a program.

### BACKGROUND ART

In a switch network accommodating a plurality of services, packet transfer control may be performed using a time aware shaper (TAS) in time-sensitive networking (TSN) of the IEEE 802.1 standard (see Patent Document 1). In this case, a virtual local area network (VLAN), a priority code point (PCP), or a quality of service (QoS) is assigned to a packet as an identifier of a priority class of the packet.

In a 5th generation (5G) mobile communication system, to implement a low-delay service using ultra reliable and low latency communication (URLLC) or the like, grant free (configured grant) is defined for uplink packet transfer (see Non Patent Documents 2 and 3).

### CITATION LIST

### Patent Document

Patent Document 1: JP 2020-092317 A

### Non Patent Documents

Non Patent Document 1: “Time-Sensitive Networking for Fronthaul”, IEEE Std P802.1CM, May 7, 2018
Non Patent Document 2: “System architecture for the 5G System (5GS)”, 3GPP TS23.501
Non Patent Document 3: “NR; NR and NG-RAN Overall Description”, 3GPP TS 38.300

### SUMMARY OF INVENTION

### Technical Problem

By using grant-free, a scheduling request of a radio terminal and a control time required for resource allocation can be reduced. Strict reliability for a control channel can be ensured.

In a fifth generation mobile communication system, an identifier with a high priority defined in a 5G QoS identifier (5QI) may be assigned to a packet of a URLLC service or the like requiring low latency.

In a “k-repetition” scheme introduced in Release 15 of “3GPP TS 38.300”, repeated transmission packets (transmission of a predetermined number of times) is performed. Therefore, the repeated transmission of the packets may be excessively performed in accordance with quality of a service provided to a radio terminal. When there are a plurality of radio terminals, there is a possibility of an improvement in reliability being limited by collision between packets transmitted from different radio terminals.

However, when there are a plurality of services requiring low latency, a priority is not given between different services. Therefore, packets of the different services are recognized as packets having the same priority. Therefore, even in a time slot used to transmit a packet with a high priority, a transfer reservation time becomes long, and there is a problem that an increase in a delay time of a packet to which an identifier with a high priority is assigned cannot be reduced.

In view of the foregoing circumstances, an object of the present invention is to provide a control device, a communication system, a control method, and a program capable of reducing an increase in delay time of a packet to which an identifier with a high priority is assigned.

### Solution to Problem

One aspect of the present invention is a control device including: a scheme determination unit configured to determine whether a packet to which an identifier of a priority is assigned is transmitted in conformity with a grant-free scheme; a time estimation unit configured to estimate a time in which a traffic volume of the packet is equal to or more than a threshold; and a transfer control unit configured to generate a control signal of a signal transfer device so that the signal transfer device transfers a packet that has arrived at the signal transfer device in the estimated time in accordance with the identifier of the priority.

Another aspect of the present invention is a communication system including: a signal transfer device configured to transfer a packet and a control device. The control device includes: a scheme determination unit determining whether a packet to which an identifier of a priority is assigned is transmitted in conformity with a grant-free scheme, a time estimation unit estimating a time in which a traffic volume of the packet is equal to or more than a threshold, and a transfer control unit generating a control signal of a signal transfer device so that the signal transfer device transfers a packet that has arrived at the signal transfer device in the estimated time in accordance with the identifier of the priority.

Still another aspect of the present invention is a control method executed by a control device. The control method includes: a scheme determining step of determining whether a packet to which an identifier of a priority is assigned is transmitted in conformity with a grant-free scheme; a time estimation step of estimating a time in which a traffic volume of the packet is equal to or more than a threshold; and a transfer control step of generating a control signal of a signal transfer device so that the signal transfer device transfers a packet that has arrived at the signal transfer device in the estimated time in accordance with the identifier of the priority.

Further still another aspect of the present invention is a program causing a computer to function as the control device.

### Advantageous Effects of Invention

According to the present invention, it is possible to reduce an increase in delay time of a packet to which an identifier with a high priority is assigned.

### BRIEF DESCRIPTION OF DRAWINGS

FIG. 1 is a diagram illustrating an exemplary configuration of a communication system in a first embodiment.

FIG. 2 is a diagram illustrating an exemplary configuration of a signal transfer control device according to the first embodiment.

FIG. 3 is a diagram illustrating an example of a time-series traffic volume related to a signal transfer device according to the first embodiment.

FIG. 4 is a flowchart illustrating an exemplary operation of the signal transfer control device according to the first embodiment.

FIG. 5 is a diagram illustrating an exemplary configuration of a communication system according to a second embodiment.

FIG. 6 is a diagram illustrating an exemplary configuration of a signal transfer control device according to the second embodiment.

FIG. 7 is a diagram illustrating an exemplary hardware configuration of a signal transfer control device according to each embodiment.

### DESCRIPTION OF EMBODIMENTS

Embodiments of the present invention will be described in detail with reference to the drawings.

### First Embodiment

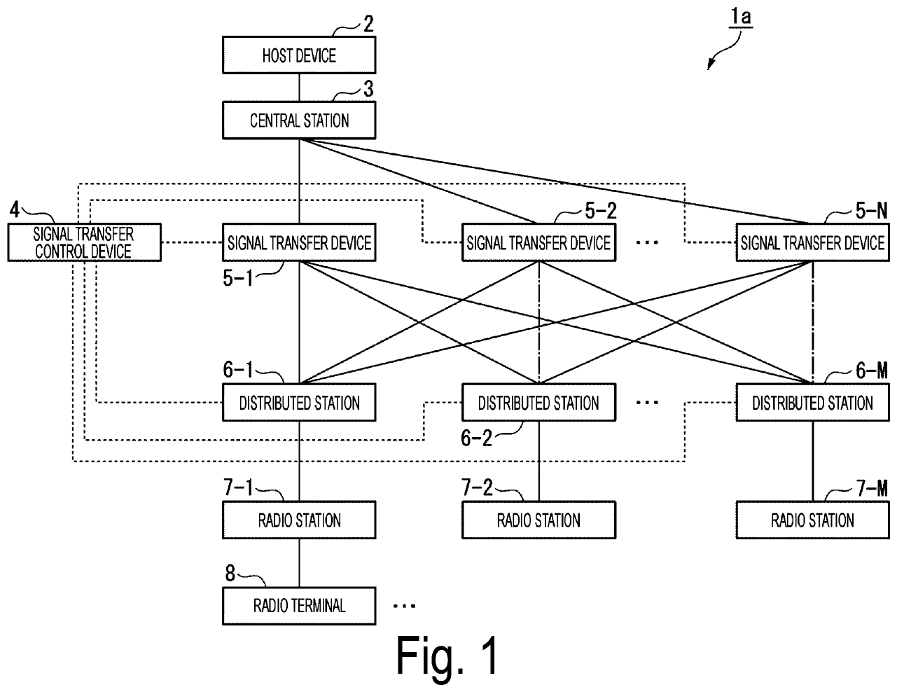

FIG. 1 is a diagram illustrating an exemplary configuration of a communication system 1a according to a first embodiment. The communication system 1a is a system that performs communication using signals (packets). The packets are transmitted along a predetermined route (path) including one or more signal transfer devices.

An identifier of a priority assigned to a packet is not limited to an identifier of a specific scheme. For example, an identifier with a high priority defined in a 5G QoS identifier (5QI) is assigned to the packet in advance. For example, an identifier with a high priority defined in VLAN, PCP, or QoS may be assigned to a packet in advance. The packet may be a packet for a low latency service using ultra reliable and low latency communication (URLLC) or the like.

The communication system 1a includes a host device 2, a central station 3, a signal transfer control device 4, N (where N is an integer of 1 or more) signal transfer devices 5, M (where M is an integer of 1 or more) distributed stations 6, and M radio stations 7. One or more radio terminals 8 can be connected to be able to communicate with the radio station 7 associated with the distributed station 6.

The host device 2 acquires uplink data from the radio terminal 8 via the radio station 7, the distributed station 6, the signal transfer device 5, and the central station 3. The host device 2 transmits downlink data to the radio terminal 8 via the central station 3, the signal transfer device 5, the distributed station 6, and the radio station 7.

The central station 3 acquires signals from one or more signal transfer devices 5. The central station 3 transmits the uplink data corresponding to the acquired signal to the host device 2. The central station 3 acquires the downlink data from the host device 2. The central station 3 transmits a signal corresponding to the downlink data to each signal transfer device 5.

The signal transfer control device 4 (control device) acquires cooperation information of which the distributed station 6 provides notification in scheduling units (for example, a transmission time interval (TTI) or a slot unit) of predetermined radio resources. The cooperation information is information used for cooperation between the signal transfer control device 4 and the distributed station 6. The time interval (transmission time interval) in the scheduling units is, for example, 1 ms or 125 μs.

The cooperation information includes, for example, radio resource control (RRC) information. The radio resource control information includes, for example, information indicating that the packet is transmitted in conformity with a grant-free scheme. The information indicating that the packet has been transmitted in conformity with a grant-free scheme is, for example, “ConfiguredGrantConfig” information.

The cooperation information may include scheduling information (Open Radio Access Network (O-RAN) Cooperative transport interface (CTI)) (ITU-T G. 989.3 Amd.3 G. suppl. 66) of the radio terminal 8 as information (band information) regarding a traffic volume. The scheduling information may be, for example, downlink control information (DCI).

The cooperation information may include, for example, information defined in a specification number “TS 28.552” of the Third Generation Partnership Project (3GPP). The information defined in the specification number “TS 28.552” is, for example, information (session information) (UE active) regarding the number of connections of a user terminal in a cell and average throughput information of the user terminal.

The cooperation information may include, for example, information defined in 3GPP specification numbers “TS 23.502 4.2.2” and “TS 38.401”. The information defined in the specification numbers “TS 23.502 4.2.2” and “TS 38.401” is, for example, “Registration information” (UE Registration) of the user terminal.

A packet transmitted in conformity with the grant-free scheme is a packet (user data) transmitted from the radio terminal 8 when the radio terminal 8 is not notified of the grant (transmission permission). A packet transmitted in conformity with the grant-based scheme is a packet (user data) transmitted from the radio terminal 8 after the radio terminal 8 is notified of a grant (transmission permission).

The signal transfer control device 4 updates the scheduling information of the signal transfer device 5 that transfers a packet in accordance with the identifier (priority class) of the priority assigned to the packet and whether the packet is transmitted in conformity with the grant-free scheme or the grant-based scheme.

When it is determined that the packet has been uplink-transmitted in conformity with the grant-free scheme, the signal transfer control device 4 may select a path (route) in the network based on information regarding a network topology of the plurality of signal transfer devices 5. The selected one path is, for example, a shortest path (shortest route) between the central station 3 and the distributed station 6.

The signal transfer control device 4 transmits a control signal indicating the scheduling information to the signal transfer device 5 along the selected path. The signal transfer control device 4 may transmit a control signal indicating the selected path to the signal transfer device 5 along the selected path. When the signal transfer device 5 acquires the control signal indicating the selected path, the signal transfer device 5 configures the selected path. The control signal may include control information (for example, “OpenConfig”) of a physical port. The signal transfer control device 4 updates the scheduling information of the signal transfer device 5 using the control signal indicating the scheduling information.

The communication system 1a may further include one or more signal transfer devices 5. The selected one path may include a plurality of signal transfer devices 5. When the selected one path includes the plurality of signal transfer devices 5, the signal transfer control device 4 transmits a control signal indicating the scheduling information to each signal transfer device 5 in the selected one path. The signal transfer control device 4 may transmit a control signal indicating the selected path to each signal transfer device 5 in the selected one path.

The signal transfer device 5 is, for example, a Layer 2 switch. The signal transfer device 5 acquires the control signal from the signal transfer control device 4. The plurality of signal transfer devices 5 transfer signals (packets) between the central station 3 and the distributed station 6 in conformity with, for example, the TAS in the TSN of the IEEE 802.1 standard based on the scheduling information indicated by the acquired control signal. The plurality of signal transfer devices 5 may switch a path of the signal between the central station 3 and the distributed station 6 to the selected path based on the selected path indicated by the acquired control signal. Accordingly, the packet transmitted in conformity with the grant-free scheme is transferred along the path (for example, the shortest path) selected by the signal transfer control device 4.

The distributed station 6 performs communication with one or more radio terminals 8 (user terminals) via the radio station 7. The distributed station 6 acquires a radio signal corresponding to the uplink data from the radio terminal 8. The distributed station 6 transmits a signal corresponding to the uplink data to one or more signal transfer devices 5.

The distributed station 6 transmits the cooperation information to the signal transfer control device 4 at time intervals of the scheduling units of radio resources. For example, “O-RAN CTI” is known as an example of an interface in a mobile fronthaul. The distributed station 6 may notify the signal transfer control device 4 of the cooperation information by using a CTI extended as compared with such a CTI.

The radio station 7 (RU: Radio Unit) (gNB: next generation Node B) performs radio communication with the radio terminal 8. The radio terminal 8 (user terminal) (NR UE: new radio user equipment) is, for example, a mobile terminal or an Internet of Things (IoT) terminal. The radio terminal 8 transmits an uplink data signal to the distributed station 6 via the radio station 7. Accordingly, the radio terminal 8 can transmit the uplink data to the host device 2. The radio terminal 8 acquires a downlink data signal from the distributed station 6 via the radio station 7. Accordingly, the radio terminal 8 can acquire the downlink data from the host device 2.

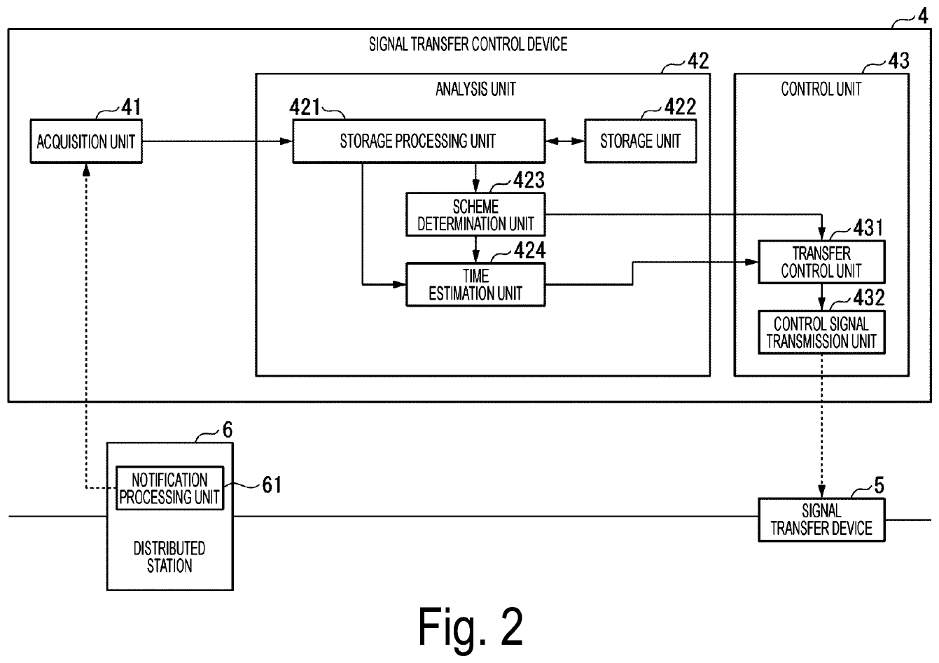

FIG. 2 is a diagram illustrating an exemplary configuration of the signal transfer control device 4 according to the first embodiment. The signal transfer control device 4 includes an acquisition unit 41, an analysis unit 42, and a control unit 43. The analysis unit 42 includes a storage processing unit 421, a storage unit 422, a scheme determination unit 423, and a time estimation unit 424. The control unit 43 includes a transfer control unit 431 and a control signal transmission unit 432. The distributed station 6 includes a notification processing unit 61.

The notification processing unit 61 notifies the acquisition unit 41 of the cooperation information in units of scheduling of radio resources. The acquisition unit 41 acquires the cooperation information from the notification processing unit 61 in units of scheduling of radio resources. The acquisition unit 41 outputs the cooperation information to the storage processing unit 421 whenever the cooperation information is acquired.

The storage processing unit 421 records the cooperation information notification of which is provided in the storage unit 422. The storage processing unit 421 may record the cooperation information notification of which is provided and a notification time in association in the storage unit 422. For example, the storage processing unit 421 records the cooperation information notification of which is provided and the notification time in association in the storage unit 422 in a form of table information.

The storage processing unit 421 outputs the cooperation information notification of which is provided to the scheme determination unit 423. The storage processing unit 421 may record the cooperation information notification of which is provided in the storage unit 422. The storage unit 422 outputs the stored cooperation information to the storage processing unit 421 in response to an instruction from the storage processing unit 421. The storage processing unit 421 may store the information regarding the network topology of the plurality of signal transfer devices 5.

Based on the cooperation information, the scheme determination unit 423 determines whether a packet is transmitted in conformity with the grant-free scheme. For example, when the notification processing unit 61 provides notification of the “ConfiguredGrantConfig” information, the scheme determination unit 423 determines that a signal is transmitted in conformity with the grant-free scheme from the radio terminal 8 associated with the distributed station 6 of the notification processing unit 61. When the notification processing unit 61 does not provide notification of the “ConfiguredGrantConfig” information, the scheme determination unit 423 determines that a signal is transmitted in conformity with the grant-based scheme from the radio terminal 8 associated with the distributed station 6 of the notification processing unit 61. The scheme determination unit 423 outputs a detection result of the transmission scheme to the transfer control unit 431.

When it is determined that the packet has been transmitted in conformity with the grant-free scheme, the scheme determination unit 423 may determine, based on the cooperation information, whether the repeated transmission of the packet (a predetermined number of transmissions) is executed. For example, when the distributed station 6 provides notification that the transmission scheme is the “k-repetition” scheme in the grant-free scheme by using the cooperation information, the scheme determination unit 423 determines that the repeated transmission of the packet (the predetermined number of transmissions) is performed. The scheme determination unit 423 outputs a detection result of the transmission scheme to the transfer control unit 431. The scheme determination unit 423 may output the detection result of the transmission scheme to the time estimation unit 424.

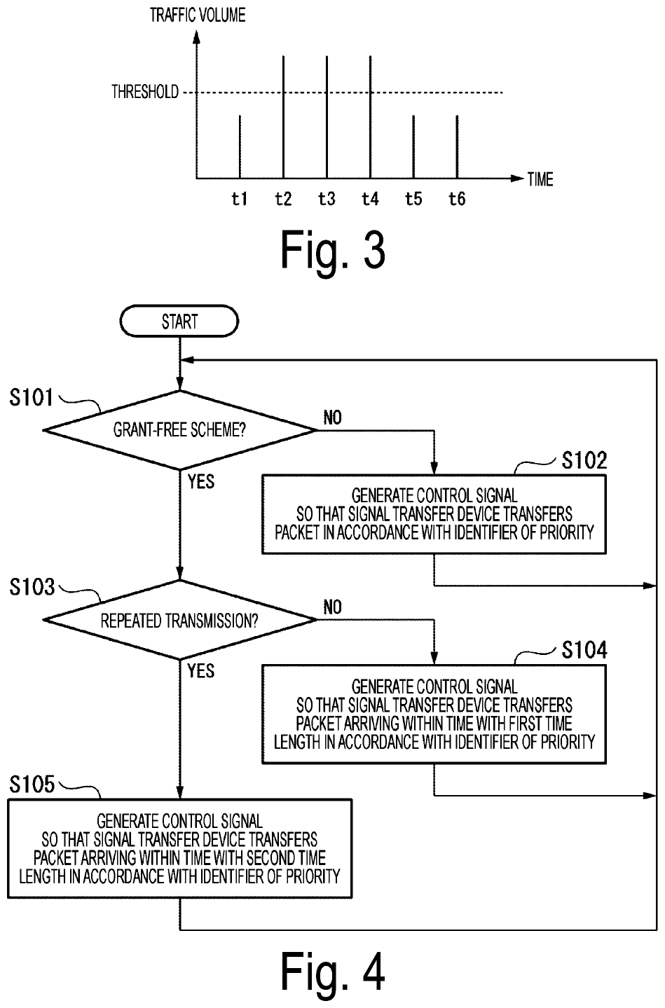

FIG. 3 is a diagram illustrating an example of a time-series traffic volume related to the signal transfer device 5 according to the first embodiment. The time estimation unit 424 estimates in advance a time (period of time) in which the packet is transmitted in conformity with the grant-free scheme based on the cooperation information notification of which was provided in the past. For example, a traffic volume of packets transmitted in the grant-free scheme is larger than a traffic volume of packets transmitted in the grant-based scheme. Therefore, the traffic volume is likely to increase within the time in which the packets are transmitted in the grant-free scheme as compared with a time in which the packets are transmitted in the grant-based scheme.

A time “t1” is, for example, a time in which the signal transfer device 5 acquires a control signal transmitted from the signal transfer control device 4. Intervals of each time illustrated in FIG. 3 are, for example, time intervals of scheduling units of radio resources. In FIG. 3, as an example, the time estimation unit 424 estimates a time (a time period from times “t2” to “t4”) in which the traffic volume is equal to or more than the threshold. In the time in which the traffic volume is equal to or greater than the threshold, there is a possibility of the packet being transmitted in conformity with the grant-free scheme. The time estimation unit 424 outputs such an estimation result of the time (first time) to the transfer control unit 431. A margin time length may be added to an estimated time length.

In a period of time from the times “t2” to “t4” in which the traffic volume is equal to or larger than the threshold, the time in which the traffic volume is actually equal to or larger than the threshold may be a continuous time from the times “t2” to “t4”, or may be periodic (discrete) times “t2”, “t3”, and “t4”.

For example, when packets are transmitted k times (for example, three times) from the radio terminal 8 in conformity with the “k-repetition” scheme, a plurality of (number corresponding to the number of slots) packets arrives at the distributed station 6 or the signal transfer device 5 k times at time intervals (transmission time intervals) of the scheduling units of the radio resources. Therefore, the time estimation unit 424 estimates a time (a period of time from the times “t2” to “t4”) in which a plurality of packets (the number of packets corresponding to the number of slots) arrives at the distributed station 6 or the signal transfer device 5 k times. The time estimation unit 424 outputs such an estimation result of the time (second time) to the transfer control unit 431. A margin time length may be added to an estimated time length. In FIG. 3, a traffic volume in a period of time from times “t5” to “t6” is, for example, less than the threshold. In a time in which the traffic volume is less than the threshold, packets may be transmitted in conformity with the grant-based scheme.

Referring back to FIG. 2, the exemplary configuration of the signal transfer control device 4 will be continuously described. The transfer control unit 431 generates a control signal based on the network topology of the plurality of signal transfer devices 5, a detection result of the transmission scheme, and an estimation result of the transmission time (transmission period of time). When it is determined that the packet has been transmitted in conformity with the grant-based scheme, the transfer control unit 431 generates a control signal indicating scheduling information of transfer so that the signal transfer device 5 transfers a packet in accordance with an identifier (priority class) with a high priority assigned to the packet. The transfer control unit 431 outputs the control signal to the control signal transmission unit 432.

When it is determined that the repeated transmission of the packet is not performed in conformity with the grant-free scheme, the transfer control unit 431 generates a control signal so that the signal transfer device 5 transfers the packet arriving at the signal transfer device 5 within a predetermined first time (a period of time from the times “t2” to “t4” illustrated in FIG. 3) in accordance with the priority class. The packet may periodically arrive within the first time. For example, the first time and a packet arrival cycle (pattern) may be derived in advance based on past cooperation information or may be derived in advance using machine learning.

When it is determined that the repeated transmission of the packet is performed in conformity with the grant-free scheme, the transfer control unit 431 generates a control signal so that the signal transfer device 5 transfers the packet arriving at the signal transfer device 5 within a predetermined second time (within a period of the repeated transmission) in accordance with the priority class. The second time may be a time different from the above-described first time or may be the same time as the above-described first time. A packet may periodically arrive within the second time (within the time from the times “t2” to “t4” illustrated in FIG. 3). The second time and the packet arrival cycle (pattern) may be derived in advance based on, for example, past cooperation information or may be derived in advance using machine learning.

When it is determined that the packet has been transmitted in conformity with the grant-based scheme, the transfer control unit 431 generates a control signal indicating scheduling information of transfer so that the signal transfer device 5 transfers the packet in accordance with the identifier (priority class) of the priority assigned to the packet. The transfer control unit 431 outputs a control signal to the control signal transmission unit 432 at the time “t1” illustrated in FIG. 3.

The control signal transmission unit 432 transmits the control signal to each signal transfer device 5. In the signal transfer device 5, a transfer timing of a packet with a high priority is controlled by updating the scheduling information of the packet transfer based on the control signal.

Next, an exemplary operation of the communication system 1a is described.

FIG. 4 is a flowchart illustrating an exemplary operation of the signal transfer control device 4 according to the first embodiment. Based on the cooperation information, the scheme determination unit 423 determines whether a packet is transmitted from the radio terminal 8 in conformity with the grant-free scheme (step S101).

When it is determined that the packet is transmitted from the radio terminal 8 in conformity with the grant-based scheme (NO in step S101), the transfer control unit 431 generates a control signal indicating the scheduling information of transfer so that the signal transfer device 5 transfers the packet in accordance with the identifier of the priority assigned to the packet (step S102). The transfer control unit 431 returns the process to step S101.

When it is determined that the packet is transmitted from the radio terminal 8 by the grant-free scheme (YES in step S101), the transfer control unit 431 determines whether the repeated transmission of the packet is performed based on the cooperation information (step S103).

When it is determined that the repeated transmission of the packet is not performed (NO in step S103), the transfer control unit 431 generates a control signal so that the signal transfer device 5 transfers the packet arriving at the signal transfer device 5 within the first time (within a time with the first time length) from the time in which the signal transfer device 5 acquires the control signal in accordance with the identifier of the priority (step S104). The transfer control unit 431 returns the process to step S101.

When it is determined that the repeated transmission of the packet is executed (YES in step S103), the transfer control unit 431 generates the control signal so that the signal transfer device 5 transfers the packet arriving at the signal transfer device 5 within the second time (within a time with the second time length) from the time in which the signal transfer device 5 acquires the control signal in accordance with the identifier of the priority (step S105). The transfer control unit 431 returns the process to step S101.

As described above, the scheme determination unit 423 determines whether the packet to which the identifier of the priority is assigned is transmitted in conformity with the grant-free scheme. The time estimation unit 424 estimates a time in which the traffic volume of the packet is equal to or greater than the threshold. The transfer control unit 431 generates the control signal of the signal transfer device 5 so that the signal transfer device 5 transfers the packet arriving at the signal transfer device in the estimated time according to the identifier of the priority.

The scheme determination unit 423 may determine whether the repeated transmission of the packets is performed. When it is determined that the repeated transmission of the packets is performed, the time estimation unit 424 may estimate a time in which a plurality of (for example, a number corresponding to the number of slots) packets arrive at the signal transfer device 5 a predetermined number of times at predetermined time intervals.

Accordingly, it is possible to reduce an increase in the delay time of the packet to which the identifier with the high priority is assigned.

### Second Embodiment

A second embodiment is different from the first embodiment in that a distributed station control device that controls distributed stations 6 transmits radio resource control information to a signal transfer control device 4. In the second embodiment, the differences from the first embodiment will be mainly described.

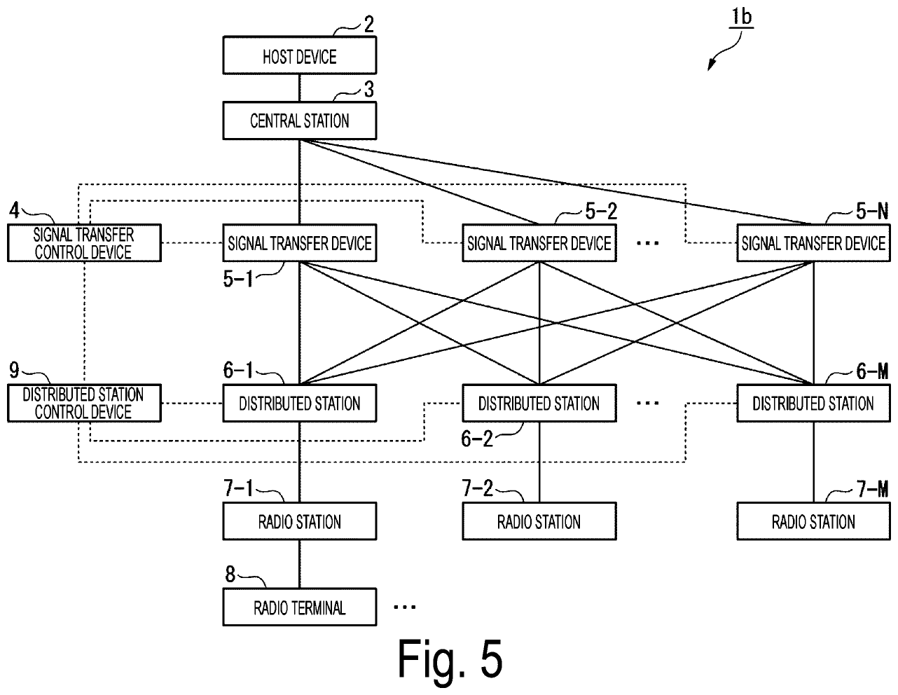

FIG. 5 is a diagram illustrating an exemplary configuration of a communication system 1b according to the second embodiment. The communication system 1b includes a host device 2, a central station 3, a signal transfer control device 4, N signal transfer devices 5, M distributed stations 6, M radio stations 7, and a distributed station control device 9. One or more radio terminals 8 can be connected to be able to communicate with the radio station 7 associated with the distributed station 6.

The distributed station 6 transmits the cooperation information to the distributed station control device 9 at time intervals of scheduling units of radio resources. The distributed station control device 9 (cooperation information transfer device) transmits the cooperation information to the signal transfer control device 4 at the time intervals of the scheduling units of radio resources. The distributed station control device 9 may control operations of the distributed stations 6. The signal transfer control device 4 acquires the cooperation information from the distributed station control device 9.

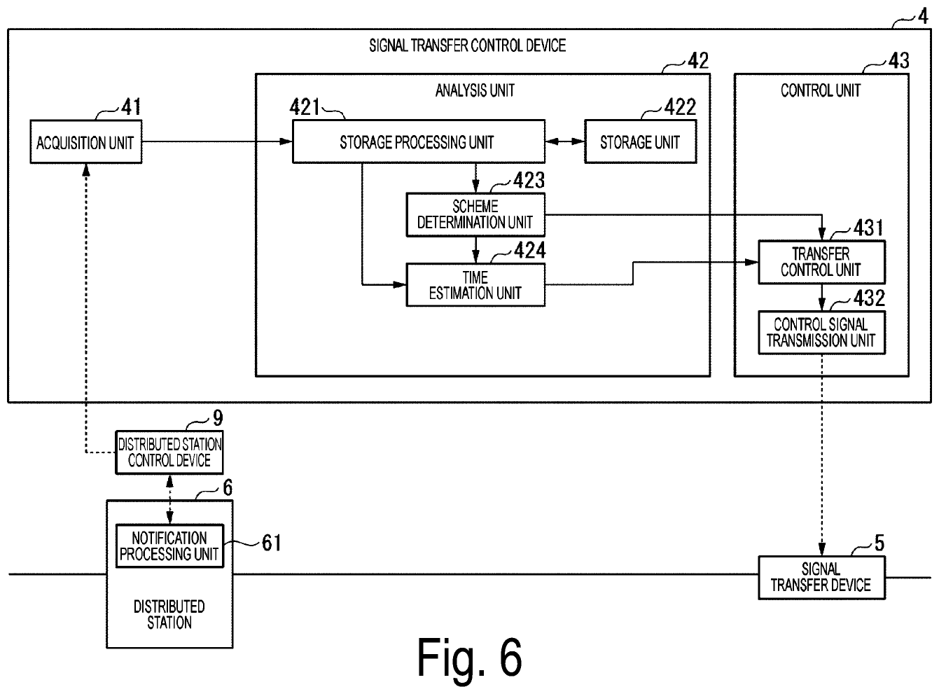

FIG. 6 is a diagram illustrating an exemplary configuration of the signal transfer control device 4 according to the second embodiment. The notification processing unit 61 notifies the distributed station control device 9 of the cooperation information at the time intervals of the scheduling units of radio resources. The distributed station control device 9 transmits the cooperation information of each distributed station 6 to the acquisition unit 41 at the time intervals of the scheduling units of radio resources. The acquisition unit 41 acquires the cooperation information from the distributed station control device 9.

As described above, the distributed station control device 9 transmits the cooperation information of each distributed station 6 to the acquisition unit 41 at the time intervals of the scheduling units of radio resources. Accordingly, it is possible to reduce an increase in the delay time of the packet to which the identifier with the high priority is assigned even if each distributed station 6 does not notify the signal transfer control device 4 of the cooperation information.

### Exemplary Hardware Configuration

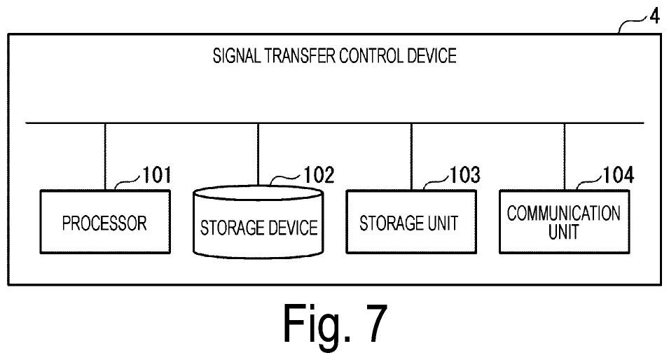

FIG. 7 is a diagram illustrating an exemplary hardware configuration of the signal transfer control device 4 in each embodiment. Some or all of the functional units of the signal transfer control device 4 are implemented as software by causing a processor 101 such as a central processing unit (CPU) to execute a program stored in a storage device 102 including a nonvolatile recording medium (non-transitory recording medium) and a storage unit 103. The program may be recorded in a computer-readable non-transitory recording medium. The computer-readable non-transitory recording medium is, for example, a portable medium such as a flexible disk, a magnetic disk, a read only memory (ROM), or a compact disc read only memory (CD-ROM), or a non-transitory recording medium such as a storage device such as a hard disk built in a computer system. The communication unit 104 performs a predetermined communication process. The communication unit 104 may acquire data and a program.

Some or all of the functional units of the signal transfer control device 4 may be implemented by using, for example, hardware including an electronic circuit (electronic circuit or circuitry) using a large scale integrated circuit (LSI), an application specific integrated circuit (ASIC), a programmable logic device (PLD), a field programmable gate array (FPGA), or the like.

As described above, the embodiments of the present invention have been described in detail with reference to the drawings. On the other hand, the specific configuration is not limited to the embodiments, and includes design without departing from the spirit of the present invention.

### INDUSTRIAL APPLICABILITY

The present invention is applicable to a communication system using a switch network.

### REFERENCE SIGNS LIST

1a, 1b Communication system
2 Host device
3 Central office
4 Signal transfer control device
5 Signal transfer device
6 Distributed station
7 Radio station
8 Radio terminal
9 Distributed station control device
41 Acquisition unit
42 Analysis unit
43 Control unit
61 Notification processing unit
101 Processor
102 Storage device
103 Storage unit
104 Communication unit
421 Storage processing unit
422 Storage unit
423 Scheme determination unit
424 Time estimation unit
431 Transfer control unit
432 Control signal transmission unit

1. A control device comprising:
a scheme determiner configured to determine whether a packet to which an identifier of a priority is assigned is transmitted in conformity with a grant-free scheme;
a time estimator configured to estimate a time in which a traffic volume of the packet is equal to or more than a threshold; and
a transfer controller configured to generate a control signal of a signal transfer device so that the signal transfer device transfers a packet that has arrived at the signal transfer device in the estimated time in accordance with the identifier of the priority.

2. The control device according to claim 1,
wherein the scheme determiner determines whether the repeated transmission of the packet is performed, and
wherein the time estimator estimates a time in which the plurality of packets arrive at the signal transfer device a predetermined number of times at predetermined time intervals when it is determined that the repeated transmission of the packets is performed.

3. A communication system comprising: a signal transfer device configured to transfer a packet: and a control device,
wherein the control device includes:
a scheme determiner determining whether the packet to which an identifier of a priority is assigned is transmitted in conformity with a grant-free scheme,
a time estimator estimating a time in which a traffic volume of the packet is equal to or more than a threshold, and
a transfer controller generating a control signal of a signal transfer device so that the signal transfer device transfers a packet that has arrived at the signal transfer device in the estimated time in accordance with the identifier of the priority.

4. A control method executed by a control device, the control method comprising:
determining whether a packet to which an identifier of a priority is assigned is transmitted in conformity with a grant-free scheme;
estimating a time in which a traffic volume of the packet is equal to or more than a threshold; and
generating a control signal of a signal transfer device so that the signal transfer device transfers a packet that has arrived at the signal transfer device in the estimated time in accordance with the identifier of the priority.

5. A non-transitory computer readable medium which stores a program causing a computer to function as the control device according to claim 1.
